(19) United States
(12) Patent Application Publication
(10) Pub. No.: US 2006/0198326 A1
(43) Pub. Date: Sep. 7, 2006

(54) IP multicast streaming data error correction

(76) Inventors: Yifan Yang, Seattle, WA (US); Robert B. McDonough, Kent, WA (US)

Correspondence Address: HARNESS, DICKEY & PIERCE, P.L.C., P.O. BOX 828, BLOOMFIELD HILLS, MI, 48303, US

(21) Appl. No.: 11/074,381

(22) Filed: Mar. 7, 2005

(51) Int. Cl. H04Q 11/00; H04L 12/16; H04Q 7/00

(52) U.S. Cl. 370/270; 370/328

(57) ABSTRACT

A method for multicasting Internet Protocol (IP) streaming data to a mobile platform passenger is provided. The method includes receiving data content at a base station network from a content provider. The received data is formatted at the base station into an IP multicast data stream and communicated to a mobile platform communications system onboard a mobile platform. The mobile platform communications system includes a local area network (LAN) used to distribute the IP multicast data stream to at least one mobile platform client interface. The data content of the IP multicast data stream is then displayed on the mobile platform client interface for viewing by a mobile platform passenger. Additionally, the method includes applying forward error correction (FEC) to the IP multicast data stream to correct for data losses, prior to distributing the IP multicast data stream to the mobile platform client interface. The method further includes decoding the FEC encoded IP multicast data stream so that the corrected data content can be interpreted and displayed on the mobile platform client interface.

### FIELD OF INVENTION

The invention relates generally to the communication of streaming data to a mobile platform and more particularly to correcting data loss errors that occur during wireless transmission of Internet Protocol (IP) multicast data streams.

### BACKGROUND OF THE INVENTION

The transmission of reliable multicast data over wireless channels is typically unreliable due to data losses during the transmission. Conversely, unicast wireless transmissions, e.g. TCP transactions, for such things as ‘surfing’ the Internet and e-mail transmissions are generally more reliable because unicast transmissions are acknowledged transmissions. That is, when a packet of data is sent, via unicast transmissions, an acknowledgement is returned indicated whether or not the data packet was received. Thus, if a data packet is not received, the acknowledgement indicates so and the data packet is resent to correct the error. However, multicast data transmissions do not include an acknowledgement and have no embedded correction mechanism. Thus, if any bit errors occur in a packet, the entire packet can be corrupted and lost, the sender will be unaware of the lost data, and the target receives streaming data that is missing data. For example, packets in a multicast audio or video stream, are quite large, e.g. 1500 bytes, thus, losing one packet can result in ‘choppy’ streaming, ‘freeze frames’ or gaps in the audio or video.

The occurrence of data loss can be amplified when the wireless multicast streaming data is transmitted within a closed environment such as a mobile platform, e.g. an aircraft, train, bus or ship. The characteristics of wireless multicast transmissions within a mobile platform are such that the electromagnetic waves can propagate through the interior of the mobile platform and cause destructive interference with each other. Even further losses can occur within a closed environment due to hardware characteristic of the devices receiving the multicast signals, e.g. laptop computers. The wireless cards or antennas of the receiving devices can be very inefficient and cause considerable packet loss. Additionally, typically the error correction software accompanying such devices provide only a low level, inefficient correction scheme.

Therefore, it would be desirable to wirelessly multicast streaming data, e.g. live news, sports, etc., within a closed environment, such as a mobile platform, efficiently and with error correction to correct for data loss.

### BRIEF SUMMARY OF THE INVENTION

In a preferred embodiment of the present invention, a method for multicasting Internet Protocol (IP) streaming data to a mobile platform passenger is provided. The method includes receiving data content at a base station network from a content provider. The received data is formatted at the base station into an IP multicast data stream and communicated to a mobile platform communications system onboard a mobile platform. The mobile platform communications system includes a local area network (LAN) used to distribute the IP multicast data stream to at least one mobile platform client interface, e.g. a laptop computer. The data content of the IP multicast data stream is then displayed on the mobile platform client interface for viewing by a mobile platform passenger or crew member. Additionally, the method includes applying forward error correction (FEC) to the IP multicast data stream to correct for data losses, prior to distributing the IP multicast data stream to the mobile platform client interface. The method further includes decoding the FEC encoded IP multicast data stream so that the corrected data content can be interpreted and displayed on the mobile platform client interface.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention. Furthermore, the features, functions, and advantages of the present invention can be achieved independently in various embodiments of the present inventions or may be combined in yet other embodiments.

### BRIEF DESCRIPTION OF THE DRAWINGS

The present invention will become more fully understood from the detailed description and accompanying drawings, wherein;

FIG. 1 is a general schematic illustrating a Internet protocol multicast communication system that implements forward error correction, in accordance with the present invention;

FIG. 2 is a general schematic illustrating an onboard communications system shown in FIG. 1;

FIG. 3 is a general schematic illustrating a base station shown in FIG. 1;

FIG. 4 is a general schematic illustrating one preferred alternate embodiment of the onboard communications system shown in FIG. 2;

FIG. 5 is a general schematic illustrating one preferred alternate embodiment of the base station shown in FIG. 3; and

FIG. 6 is a flow chart illustrating a method of operation of the Internet protocol multicast communication system, shown in FIG. 1.

Corresponding reference numerals indicate corresponding parts throughout the several views of drawings.

### DETAILED DESCRIPTION OF THE INVENTION

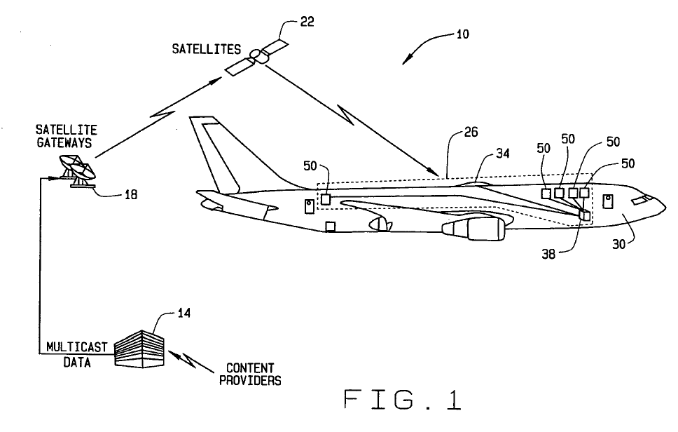

FIG. 1 is a general schematic illustrating an Internet Protocol multicast communication system (IPMCS) 10 that implements forward error correction (FEC), in accordance with preferred embodiments of the present invention. The IPMCS 10 includes at least one base station 14, at least one satellite gateway 18, at least one satellite 22 and a mobile platform communications system 26, e.g. a local area network (LAN), onboard a mobile platform 30. In a preferred embodiment, the mobile platform communications system 26 is a wireless LAN. Although the mobile platform 30 is illustrated in FIG. 1 as an aircraft, it should be understood that the mobile platform 30 could be any mobile platform that includes an onboard communication system 26, for example, land vehicles such as a bus, a train or an automobile, and maritime vehicles, such as a cruise ship.

Generally, the base station 14 receives streaming data from a content provider that can be any multimedia source adapted to provide information and/or entertainment data. For example, the content provider can be any multimedia source that provides such things as news, sports, music, movies, stock market information, Internet access and other types of information or entertainment data. The base station 14 formats the data from the content provider into an internet protocol (IP) multicast data stream that is communicated to the satellite gateway 18.

A multicast data stream is a non-acknowledgement transaction, as opposed to a unicast data stream which sends an acknowledgement back indicating whether an end user device received all the data intact. Thus, if data bits or data packets are not received by the end user device, the device will not know there is missing or lost data and improperly or incompletely interpret and/or display the data content. Generally, multicast is more efficient than unicast in distributing the same data to multiple recipients. Unicast send data as many times as there are recipients, whereas multicast will distribute the data to all recipients in a single transmission. Wireless communications such as communications to a mobile platform is typically restricted to low bandwidth, for example 5 to 10 megabits that would only support a few, e.g. six or seven, end user devices using unicast scheme. Thus, communications to and/or within mobile platforms generally incorporate multicast to efficiently transmit data to multiple recipients.

The IP multicast data stream can be communicated between the base station 14 and the satellite gateway 18 using any suitable wired or wireless communication means. The IP multicast data stream is communicated from the satellite gateway 18 to the satellite 22 and then to the onboard communications system 26, particularly to an antenna 34 included in the onboard communications system 26. The antenna 34 is communicatively connected to a receive/distribute subsystem 38 of the onboard communications system 26.

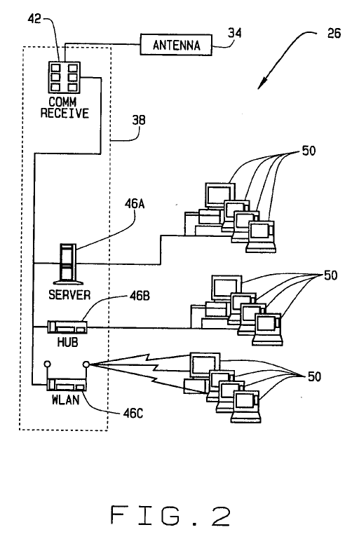

Referring to FIG. 2, the onboard communications system 26 includes a communications receiving component 42 that receives the IP multicast data stream from the antenna 34. The communications receiving component 42 then communicates the IP multicast data stream to a distribution component 46, which can be any suitable network distribution device such as a server 46A, a network hub 46B or a wireless local area network (WLAN) 46C. The distribution component 46 distributes at least the content of the IP multicast data stream to one or more mobile platform client interfaces 50, as described in further detail below. In one preferred embodiment the communication between the distribution component 46 and the client interface 50 is wireless communication. The client interface 50 can be any computer based device suitable for receiving at least the data content from the distribution component 46 and displaying the data content to be viewed by a passenger or crew member of the mobile platform. For example, the client interface 50 can be a computer based input/output device install onboard the mobile platform in crew quarters accessible by crew members or in a passenger cabin accessible by passengers of the mobile platform. Or, the client interface 50 can be a portable laptop computer, personal data assistant (PDA), cell phone or other portable computer based communication device carried onto the mobile platform or distributed onboard the mobile platform and communicatively connected to the distribution device 46.

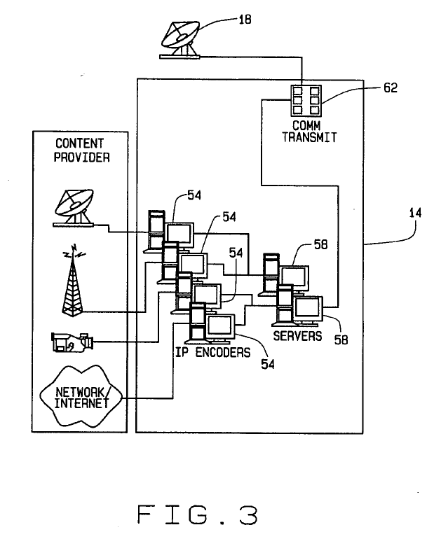

Referring now to FIG. 3, the base station 14 includes at least one IP encoder 54 that receives the streaming data from the content provider and formats, i.e. encodes, the data into IP data. As described above, the content provider can be any multimedia source adapted to provide information and/or entertainment data. For example, the content provider can be a satellite gateway, a terrestrial communications system, the Internet, stored media or a direct input/output device such as a video camera. The IP encoder 54 formats the data from the content provider into IP data and generates an IP multicast data stream that is communicated to at least one base station server 58. The base station server 58 communicates the IP multicast data stream to a communication transmission component 62 that, in turn, communicates the IP multicast data stream to the satellite gateway 18.

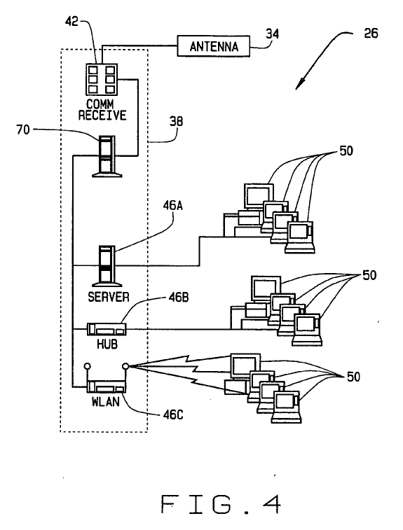

Referring now to FIGS. 3 and 4, in one preferred embodiment of the present invention, the mobile platform receive/distribute subsystem 38 includes a FEC processing component 70. The FEC processing component 70 is configured to encode the IP multicast data stream received from mobile platform communications receiving component 42 with FEC. The FEC processing component 70 encodes the IP multicast data stream using FEC to correct for lost data bits or packets. Generally, FEC constructs mathematical formulas used to recover lost data and may add information to the original data stream, e.g. protection packets, and/or remap the original data stream to a new data stream to increase the likelihood of reconstructing the original data stream. The FEC processing component 70 can be either a software component or an independent device of the receive/distribute subsystem 38 and can implement any suitable form of FEC known in the art that can be configured relative to the mobile platform in which it is implemented, e.g. Reed-Solomon type coding.

In one implementation of this embodiment, the FEC processing component 70 encodes the IP multicast data stream and communicates the FEC encoded IP multicast data stream to the mobile platform server 46A, which in turn, communicates the FEC encoded IP multicast data stream to the client interface 50, via either wired or wireless connections. The client interface 50 includes IP and FEC decoding software adapted to decode the IP format and the FEC of the FEC encoded IP multicast data stream so that the decoded data content can be displayed and viewed by either a passenger or crew member.

Still referring to FIGS. 3 and 4, in another preferred embodiment, the FEC processing component 70 encodes the IP multicast data stream and communicates the FEC encoded IP multicast data stream to the mobile platform hub 46B, via wired or wireless connections. The mobile platform hub 46B communicates the FEC encoded IP multicast data stream to the client interface 50, via either wired or wireless connections. The client interface utilizes IP and FEC decoding software to decode the IP format and the FEC of the FEC encoded IP multicast data stream and display the decoded data content to be viewed by either a passenger or crew member.

Still referring to FIGS. 3 and 4, in yet another preferred embodiment, the FEC processing component 70 encodes the IP multicast data stream and communicates the FEC encoded IP multicast data stream to the mobile platform WLAN 46C, via wired or wireless connections. The mobile platform WLAN 46C wirelessly communicates the FEC encoded IP multicast data stream to the client interface 50. The client interface utilizes IP and FEC decoding software to decode the IP format and the FEC of the FEC encoded IP multicast data stream and display the decoded data content to be viewed by either a passenger or crew member.

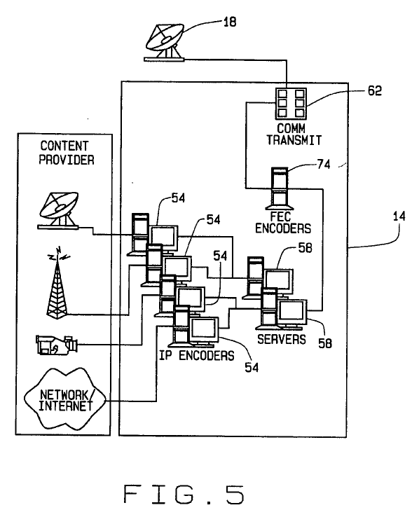

Referring to FIG. 5, in one embodiment the base station 14 includes a forward error correction (FEC) encoder 74 that receives the IP multicast data stream from the base station server 58. The base station FEC encoder 74 encodes the IP multicast data stream using FEC to correct for lost data bits or packets. Generally, FEC constructs mathematical formulas used to recover lost data and may add information to the original data stream, e.g. protection packets, and/or remap the original data stream to a new data stream to increase the likelihood of reconstructing the original data stream. The FEC encoder 74 can be either a software component or an independent device of the base station 14 and can implement any suitable form of FEC known in the art that can be configured relative to the mobile platform in which it is implemented, e.g. Reed-Solomon FEC.

The FEC encoder 74 then communicates the FEC encoded IP multicast data stream to the communications transmission component 62 that, in turn communicates the FEC encoded IP multicast data stream to the satellite gateway 18 and subsequently to the mobile platform communications receiving component 42, via the satellite 22 and the mobile platform antenna 34.

Referring to FIGS. 2 and 5, in one preferred embodiment the communications receiving component 42 communicates the FEC encoded IP multicast data stream, via either wired or wireless connections, to the mobile platform server 46A. In one implementation of this embodiment, the mobile platform server 46A communicates the FEC encoded IP multicast data stream to the client interface 50, via either wired or wireless connections. The client interface 50 includes IP and FEC decoding software adapted to decode the IP format and the FEC of the FEC encoded IP multicast data stream so that the decoded data content can be displayed and viewed by either a passenger or crew member.

Still referring to FIGS. 2 and 5, in another preferred embodiment the communications receiving component 42 communicates the FEC encoded IP multicast data stream, via either wired or wireless connections, to the mobile platform hub 46B. The mobile platform hub 46B communicates the FEC encoded IP multicast data stream, via either wired or wireless connections, to the client interface 50 that includes IP and FEC decoding software. Thus, the client interface 50 decodes the IP format and the FEC of the FEC encoded IP multicast data stream and displays the decoded data content to be viewed by either a passenger or crew member.

Still further referring to FIGS. 2 and 5, in yet another preferred embodiment the communications receiving component 42 communicates the FEC encoded IP multicast data stream, via either wired or wireless connections, to the mobile platform WLAN 46C. The mobile platform WLAN 46C wirelessly communicates the FEC encoded IP multicast data stream to the client interface 50 that includes IP and FEC decoding software. Thus, the client interface 50 decodes the IP format and the FEC of the FEC encoded IP multicast data stream and displays the decoded data content to be viewed by either a passenger or crew member.

Referring now to FIGS. 4 and 5, in one preferred personification of the present invention, the FEC processing component 70 is configured to FEC decode the FEC encoded IP multicast data stream, and/or the FEC processing component 70 can be configured to FEC decode and then re-encode the IP multicast data stream with FEC. Thus, in one embodiment, the FEC processing component 70 receives the FEC encoded IP multicast data stream from the mobile platform communications receiving component 42 and communicates with the mobile platform server 46A, via wired or wireless connections. In one implementation of this embodiment the FEC processing unit decodes the FEC of the FEC encoded IP multicast data stream and communicates the IP multicast data stream to the mobile platform server 46A. The mobile platform server 46A decodes the IP multicast data stream and communicates a data stream in a format that can be understood by the client interface 50, via either wired or wireless connections. The client interface 50 then displays the data content of the multicast data stream to be viewed by either a passenger or crew member.

In another implementation of this embodiment, the FEC processing component 70 decodes the FEC of the FEC encoded IP multicast data stream and communicates the IP multicast data stream to the mobile platform server 46A, which in turn, communicates the IP multicast data stream to the client interface 50, via either wired or wireless connections. The client interface 50 includes IP decoding software adapted to decode the IP of the IP multicast data stream so that the decoded data content can be displayed and viewed by either a passenger or crew member.

In yet another implementation of this embodiment, the FEC processing component 70 decodes the FEC, then re-encodes the IP multicast data stream with FEC and communicates the FEC re-encoded IP multicast data stream, via wired or wireless connections, to the mobile platform server 46A. The mobile platform server 46A communicates the FEC re-encoded IP multicast data stream to the client interface 50, via either wired or wireless connections. The client interface 50 includes IP and FEC decoding software adapted to decode the IP format and the FEC of the FEC re-encoded IP multicast data stream so that the decoded data content can be displayed and viewed by either a passenger or crew member.

In still yet another implementation of this embodiment, the FEC processing component 70 adds a second layer of FEC to the existing FEC encoded IP multicast stream, creating a cumulative FEC protected stream. The FEC processing component 70 then communicates the cumulative FEC encoded IP multicast data stream, via wired or wireless connections, to the mobile platform server 46A. The mobile platform server 46A communicates the FEC re-encoded IP multicast data stream to the client interface 50, via either wired or wireless connections. The client interface 50 includes IP and FEC decoding software adapted to decode the IP format and the FEC of the cumulative FEC encoded IP multicast data stream so that the decoded data content can be displayed and viewed by either a passenger or crew member.

Still referring to FIGS. 4 and 5, in another preferred embodiment, the FEC processing component 70 receives the FEC encoded IP multicast data stream from the mobile platform communications receiving component 42 and communicates with the mobile platform hub 46B, via wired or wireless connections. In one implementation of the present embodiment, the FEC processing unit decodes the FEC of the FEC encoded IP multicast data stream and communicates the IP multicast data stream to the mobile platform hub 46B. The mobile platform hub 46B communicates the IP multicast data stream to the client interface 50, via either wired or wireless connections. The client interface 50 includes IP decoding software adapted to decode the IP of the IP multicast data stream so that the decoded data content can be displayed and viewed by either a passenger or crew member.

In another implementation of the this embodiment, the FEC processing component 70, decodes the FEC, then re-encodes the IP multicast data stream with FEC and communicates a FEC re-encoded IP multicast data stream, via wired or wireless connections, to the mobile platform hub 46B. The mobile platform hub 46B communicates the FEC re-encoded IP multicast data stream, via either wired or wireless connections, to the client interface 50 that includes IP and FEC decoding software. Thus, the client interface 50 decodes the IP format and the FEC of the FEC re-encoded IP multicast data stream and displays the decoded data content to be viewed by either a passenger or crew member.

In yet another implementation of this embodiment, the FEC processing component 70 adds a second layer of FEC to the existing FEC encoded IP multicast stream, creating a cumulative FEC protected stream. The FEC processing component 70 then communicates the cumulative FEC encoded IP multicast data stream, via wired or wireless connections, to the mobile platform hub 46B. The mobile platform hub 46B communicates the FEC re-encoded IP multicast data stream to the client interface 50, via either wired or wireless connections. The client interface 50 includes IP and FEC decoding software adapted to decode the IP format and the FEC of the cumulative FEC encoded IP multicast data stream so that the decoded data content can be displayed and viewed by either a passenger or crew member.

Still referring to FIGS. 4 and 5, in yet another preferred embodiment, the FEC processing component 70 receives the FEC encoded IP multicast data stream from the mobile platform communications receiving component 42 and communicates with the mobile platform WLAN 46C, via wired or wireless connections. In one implementation of the present embodiment, the FEC processing unit decodes the FEC of the FEC encoded IP multicast data stream and communicates the IP multicast data stream to the mobile platform WLAN 46C. The mobile platform WLAN 46C wirelessly communicates the IP multicast data stream to the client interface 50. The client interface 50 includes IP decoding software adapted to decode the IP of the IP multicast data stream so that the decoded data content can be displayed and viewed by either a passenger or crew member.

In another implementation of the this embodiment, the FEC processing component 70, decodes the FEC, then re-encodes the IP multicast data stream with FEC and communicates a FEC re-encoded IP multicast data stream, via wired or wireless connections, to the mobile platform WLAN 46C. The mobile platform WLAN 46C wirelessly communicates the FEC re-encoded IP multicast data stream to the client interface 50 that includes IP and FEC decoding software. Thus, the client interface 50 decodes the IP format and the FEC of the FEC re-encoded IP multicast data stream and displays the decoded data content to be viewed by either a passenger or crew member.

In yet another implementation of this embodiment, the FEC processing component 70 adds a second layer of FEC to the existing FEC encoded IP multicast stream, creating a cumulative FEC protected stream. The FEC processing component 70 then communicates the cumulative FEC encoded IP multicast data stream, via wired or wireless connections, to the mobile platform WLAN 46C. The mobile platform WLAN 46C wirelessly communicates the FEC re-encoded IP multicast data stream to the client interface 50 that includes IP and FEC decoding software adapted to decode the IP format and the FEC of the cumulative FEC encoded IP multicast data stream so that the decoded data content can be displayed and viewed by either a passenger or crew member.

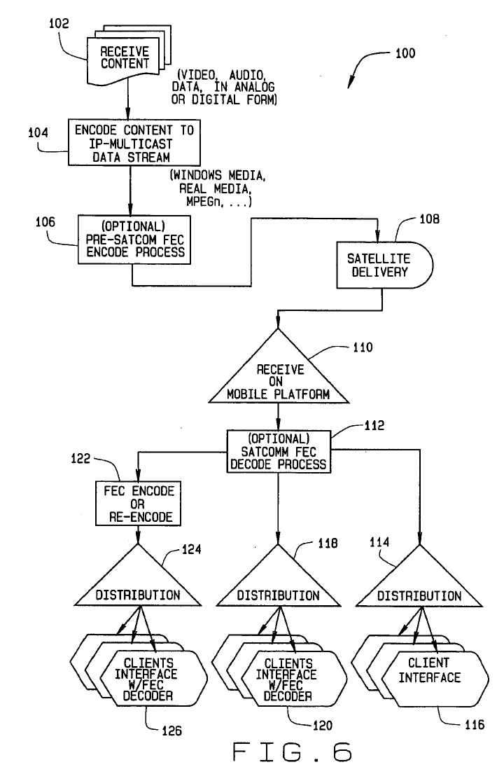

FIG. 6 is a flow chart 100 illustrating a method of operation of the IPMCS 10, shown in FIG. 1. The base station 14 receives streaming data from a content provider that can be any multimedia source adapted to provide information and/or entertainment data, as illustrate at 102. The base station 14 formats the data from the content provider into an IP multicast data stream, as indicated at 104. The IP multicast data stream can be communicated to the satellite gateway 18 or be encoded with FEC, via the base station FEC encoder 74 and then communicated to the satellite gateway 18, as indicated at 106. The IP multicast data stream or the FEC encoded IP multicast data stream is then communicated to the mobile platform communications system 26, via satellite 22, as indicated at 108 and 110. If the mobile platform communications system 26 receives an FEC encoded IP multicast data stream, the FEC encoded IP multicast data stream can optionally be FEC decoded utilizing the FEC processing component 70, as indicated at 112. The decoded IP multicast data stream is distributed to the client interface 50 and displayed, in accordance with the various embodiments described above, as indicated at 114 and 116. Alternatively, the FEC encoded IP multicast data stream is not FEC decoded by FEC processing module 38, but is distributed to the client interface 50. The client interface decodes the FEC encoded IP multicast data stream and displays the data content, in accordance with the various embodiments described above, as indicated at 118 and 120.

If the mobile platform communications system 26 receives an IP multicast data stream that has not been encoded with FEC, the IP multicast data stream is encoded with FEC utilizing the FEC processing component 70, as indicated at 122. Alternatively, if the mobile platform communications system 26 receives an FEC encoded IP multicast data stream and the FEC encoded IP multicast data stream is FEC decoded at 112, the decoded IP multicast data stream can be re-encoded with FEC utilizing the FEC processing component 70, as also indicated at 122. If the FEC encoded IP multicast data stream is not FEC decoded at 112, the FEC processing component 70 can apply further FEC encoding to the FEC encoded IP multicast data stream to create a cumulative FEC encoded IP multicast data stream. The FEC encoded, cumulative encoded, or re-encoded IP multicast data stream is distributed to the client interface 50, where the client interface decodes the FEC encoded IP multicast data stream and displays the data content, in accordance with the various embodiments described above, as indicated at 124 and 126.

While the invention has been described in terms of various specific embodiments, those skilled in the art will recognize that the invention can be practiced with modification within the spirit and scope of the claims.

What is claimed is:

1. A method for providing IP multicast streaming data to a mobile platform passenger, said method comprising:
encoding an Internet Protocol (IP) multicast data stream using forward error correction (FEC) prior to distributing the IP multicast data stream throughout a mobile platform; and
decoding the FEC encoded IP multicast data stream prior to viewing of content contained in the IP multicast data stream on a mobile platform client interface.

2. The method of claim 1, wherein encoding the IP multicast data stream using FEC comprises applying FEC to the IP multicast data stream at a base station prior to the IP multicast data stream being communicated to the mobile platform.

3. The method of claim 2, wherein decoding the IP multicast data stream comprises:
receiving the FEC encoded IP multicast data stream at the mobile platform; and
decoding the FEC encoded IP multicast data stream prior to distributing the IP multicast data stream to the mobile platform client interface.

4. The method of claim 2, wherein decoding the IP multicast data stream comprises:
receiving the FEC encoded IP multicast data stream at the mobile platform;
distributing the FEC encoded IP multicast data stream to the mobile platform client interface: and
decoding the FEC encoded IP multicast data stream at the mobile platform client interface.

5. The method of claim 2, wherein decoding the IP multicast data stream comprises:
receiving the FEC encoded IP multicast data stream at the mobile platform;
applying further FEC to the FEC encoded IP multicast data stream to generate a cumulative FEC encoded IP multicast data stream;
distributing the cumulative FEC encoded IP multicast data stream to the mobile platform client interface: and
decoding the cummulative FEC encoded IP multicast data stream at the mobile platform client interface.

6. The method of claim 1, wherein encoding the IP multicast data stream using FEC comprises:
receiving the IP multicast data stream at the mobile platform;
applying FEC to the IP multicast data stream at the mobile platform; and
distributing the FEC encoded IP multicast data stream to the mobile platform client interface.

7. The method of claim 6, wherein decoding the FEC encoded IP multicast data stream comprises:
receiving the FEC encoded IP multicast data stream at the mobile platform client interface; and
decoding the FEC encoded IP multicast data stream at the mobile platform client interface.

8. A system for providing IP multicast streaming data to a mobile platform passenger, said system comprising:
a base station network adapted to receive data content and generate an Internet Protocol (IP) multicast data stream in response thereto;
a mobile platform communications system adapted to receive the IP multicast data stream from the ground station and distribute the IP multicast data stream throughout the mobile platform, via a mobile platform local area network (LAN);
at least one mobile platform interface adapted to receive the IP multicast data stream distributed by the mobile platform LAN;
at least one forward error correction (FEC) encoder adapted to encode the IP multicast data stream using FEC prior to the IP multicast data signal being distributed by the mobile platform LAN; and
an FEC decoder adapted to decode the FEC encoded IP multicast data stream prior to viewing of content contained in the IP multicast data stream on the mobile platform client interface.

9. The system of claim 8, wherein the base station network is further adapted to digitize visual data content received from the content provider; and filter the visual data to de-interlace the visual data and remove artifacts and noise.

10. The system of claim 8, wherein the base station network includes the FEC encoder such that the IP multicast data stream is FEC encoded by the base station network and communicated to the mobile platform communications system.

11. The system of claim 10, wherein the mobile platform communications system includes the FEC decoder such that the FEC encoded IP multicast data stream is decoded prior to being distributed to the mobile platform client interface.

12. The system of claim 10, wherein the mobile platform client interface includes the FEC decoder such that the FEC encoded IP multicast data stream is decoded after being distributed to the mobile platform client interface.

13. The system of claim 8, wherein the mobile platform communications system includes the FEC encoder and the mobile platform client interface includes the FEC decoder such that the IP multicast data is FEC encoded by the mobile platform communications system, distributed to the mobile platform client interface and decoded at the mobile platform client interface.

14. The system of claim 8, wherein the FEC encoder is adapted to intercepting appropriate data within the IP multicast data stream and generating protection data packets for the intercepted data.

15. A method for providing IP multicast streaming data to a mobile platform passenger, said method comprising:
receiving data content at a base station network;
formatting the data content received to an Internet Protocol (IP) multicast data stream;
communicating the IP multicast data stream to a mobile platform communications system including a mobile platform local area network (LAN);
distributing the IP multicast data stream to at least one mobile platform client interface using the mobile platform LAN;
displaying the data content of the IP multicast data stream on the mobile platform client interface;
applying forward error correction (FEC) to the IP multicast data stream, prior to distributing the IP multicast data stream to the mobile platform client interface; and
decoding the FEC encoded IP multicast data stream prior to displaying the data content on the mobile platform client interface.

16. The method of claim 15, wherein applying the FEC comprises:
encoding the IP multicast data stream using a FEC encoder included in the base station network; and
communicating the FEC encoded IP multicast data stream to the mobile platform communication system.

17. The method of claim 16, wherein decoding the FEC encoded IP multicast data stream comprises decoding the FEC encoded multicast data stream prior to distributing the IP multicast data stream to the mobile platform client interface using a decoder included in the mobile platform communications system.

18. The method of claim 16, wherein decoding the FEC encoded IP multicast data stream comprises:
distributing the FEC encoded IP multicast data stream to the mobile platform client interface: and
decoding the FEC encoded multicast data stream at the mobile platform client interface using a decoder included in the mobile platform client interface.

19. The method of claim 15, wherein applying the FEC, comprises:
receiving the IP multicast data stream at the mobile platform communications system;
applying FEC to the IP multicast data stream using a FEC encoder included in the mobile platform communications system; and
distributing the FEC encoded IP multicast data stream to the mobile platform client interface.

20. The method of claim 19, wherein decoding the FEC encoded IP multicast data stream comprises:
receiving the FEC encoded IP multicast data stream at the mobile platform client interface; and
decoding the FEC encoded IP multicast data stream at the mobile platform client interface using a decoder included in the mobile platform client interface.

21. The method of claim 15, wherein distributing the IP multicast data stream to at least one mobile platform client interface comprises wirelessly distributing the IP multicast data stream to the mobile platform client interface via a wireless mobile platform LAN.
